(19) United States
(12) Patent Application Publication
(10) Pub. No.: US 2007/0184935 A1
(43) Pub. Date: Aug. 9, 2007

(54) U-turn signal

(76) Inventors: Richard Wallis, Coral Springs, FL (US); Maria Wallis, Coral Springs, FL (US)

Correspondence Address: RICHARD WALLIS / MARLA WALLIS, 11040 NW 37TH STREET, CORAL SPRINGS, FL, 33065, US

(21) Appl. No.: 11/346,432

(22) Filed: Feb. 3, 2006

(51) Int. Cl. B62D 11/02

(52) U.S. Cl. 477/1

(57) ABSTRACT

The “u-turn” signal would be a safety device that would be standard in all motorized vehicles as a normal safety feature such as windshield wipers, headlights, turning signals etc. It would be best to be incorporated as part of the turning signal apparatus but can also be just a button such as the emergency flashers are. Presently when a vehicle is making a u-turn they are only truly able to show that intention by a hand signal which is rarely done . This invention will prevent rear end accidents and also accidents between the vehicle making the u-turn and a vehicle which is entering the same roadway via a right turn on red.

### DESCRIPTION

When a motor vehicle is going to make a u-turn, the operator would initiate the signal with either a button located on or near the turning signal or a movement of the turning signal 2 clicks down. One click down for a left hand turn and 2 clicks down for a u-turn. It would be the opposite for motor vehicles driven in countries where the driving is done on the left side of the road . In those cases the turning signal would click up once for a right hand turn and 2 clicks up for a u-turn. When the signal is activated a illuminated “u” or a upside down “u” would flash in all areas the normal turning signal would be seen

1. The purpose of this invention would be to eliminate accidents which happens when a motor vehicle considerably slows down when making a u-turn in lieu of a regular turn.
